(19) United States
(12) Patent Application Publication
(10) Pub. No.: US 2021/0147076 A1
(43) Pub. Date: May 20, 2021

(54) A DRIVE MECHANISM

(71) Applicant: Vimaan Robert, Inc., Sunnyvale, CA (US)

(72) Inventors: Michael A. Stearns, Milpitas, CA (US); Marc Mignard, Las vegas, NV (US); Strinivasan K. Ganapathi, Palo Alto, CA (US); W. James MacKeefery, Castro Valley, CA (US)

(21) Appl. No.: 16/632,434

(22) PCT Filed: Aug. 21, 2018
(86) PCT No.: PCT/US2018/047322

§ 371 Date: Jan. 20, 2020

Related U.S. Application Data
(60) Provisional application No. 62/549,238, filed on Aug. 23, 2017.

(51) Int. Cl. B64C 39/02; B64C 27/10; B64C 11/44

(52) U.S. Cl. CPC B64C 39/024; B64C 27/10; B64C 11/44; B64C 2201/044; B64C 2201/024; B64C 2201/108; B64C 2201/042

(57) ABSTRACT

A vehicle is provided having at least one control motor that includes a drive motor having a stationary portion and a rotatable portion, where the drive motor rotatable portion is coupled to a rotor shaft, where the drive motor is configured to rotate the rotor shaft, where the rotor shaft is coupled to a rotor, at least one pitch motor having a stationary portion and a rotatable portion, where the stationary portion of the pitch motor is a stator, where each pitch motor rotatable portion includes a pitch control linkage, where the pitch motor rotatable portion is connected to the rotor through the pitch control linkage, and at least one variable pitch blade holder connected to the pitch control linkage, where a pitch angle of the blade holder is capable of being adjusted by the pitch motor within each revolution of the rotor through the use of control signals.

### FIELD OF THE INVENTION

The present invention relates generally to electromechanically driven systems, such as aerial or underwater rotor driven craft. More particularly, the invention relates to electromechanical helicopters having safe, precise, and quiet operation.

### BACKGROUND OF THE INVENTION

Popular classes of rotorcraft for Small Unmanned Aerial Vehicles (SUAVs) include helicopters having one or two rotors about a central axis and a tail rotor, and a “multi-rotors” class that have rotors arranged along two or more nearly parallel axes. These classes of rotorcraft rely on the underlying principle that lift can be changed either by changing the rotational velocity of the rotors or by changing the “pitch” of the blades, where the angle of the rotor blades changes with respect to the plane of rotation. A uniform change in rotational velocity of all the rotors results in vertical up or down motion due to increased or reduced lift, while a relative change in rotational velocity between the rotors, or a relative change in blade pitch between rotors, or a change in blade pitch within a single revolution of the rotors can all generate a horizontal component of the lift vector, which results in thrust or lateral motion of the rotorcraft.

The most popular consumer SUAVs today are based on multi-rotor technology which are interchangeably referred to as drones. Drones with four rotors are the most common and are referred to as “quad-copters” or “quad-rotor” drones, although some other drones use three, six or eight rotors. The use of multiple rotors is popular due to low cost motors, electronics, sensors and software that control the speed of the motors to maintain drone stability and enable it to hover or translate in space.

In typical multi-rotor drones, the torque generated from any single motor makes the entire drone “yaw” about the vertical axis in a direction opposite to the direction of rotation of the rotor. To counter this, adjacent motors rotate in opposing directions, which allows the drone to be stable with respect to yaw. In order to pitch or roll, which enables translation of the drone in the direction of tilt, the speed of the appropriate motors is changed, which changes the relative lift from the different motors, and results in either a pitch or roll motion or combination thereof.

Despite their popular use, multi-rotor drones suffer from several drawbacks. First, for a given area and mass footprint, multi-copters have to fit multiple rotors within a given area footprint, which results in multiple rotors each with a small radius, rather than a single rotor with a large radius. For small scale rotors especially, lifting efficiency increases with an increase in rotor diameter because thrust per torque increases with increased Reynolds number. Additionally, there are significant efficiency losses caused by rotor tips moving past each other. Therefore, multi-rotor drones are inherently less efficient than single, large rotor vehicles such as a helicopter. Additionally, to make up for the loss in lift, multi-copters traditionally operate the rotors at very high rotational velocities, which increases the frequency as well as the amplitude of the noise generated by the rotors, resulting in significant noise. Further, the maneuverability and agility of multi-rotor drones is limited, because translation is enabled by changing the motor speeds, which requires the inertia of the motors to be overcome, resulting in a relatively large time lag.

Helicopters operate differently compared to multi-rotor drones because they typically have a single rotor that does not rely on the relative changes in rotor speeds of multiple rotors to initiate lateral thrust vectors. To change flight direction, helicopters change the pitch angle of the rotor blades within a single revolution of the rotor, where the angle is measured relative to a horizontal plane of rotation of the blades. Within certain limits, a blade with a higher pitch angle generates more lift, so by setting the blade pitch high or low at different points in the rotation of the rotor, one can generate differential lift within a rotor revolution, which in turn generates a torque on the vehicle and provides the lateral thrust vector needed for translation of the helicopter. This mechanism of changing the blade pitch within a single cycle of rotor revolution is known as “cyclic pitch”. In addition to cyclic pitch, helicopters also have the ability to generate “collective pitch”, which signifies a blade pitch that can be varied, but stays constant within a single revolution. Collective pitch can be used to increase or decrease the lift of the vehicle, while cyclic pitch is used to affect a lateral thrust vector and enable lateral translations of the vehicle. Although collective pitch and rotational velocity of the rotors have the same effect of increasing or decreasing lift, collective pitch is generally used to affect rapid, small changes in lift, due to the inherently lower inertia of changing blade pitch compared to the significantly higher inertia of speeding up or slowing down the rotors.

Therefore, from an efficiency, noise and maneuverability standpoint, it is better to use a helicopter-type rotor configuration for SUAVs rather than a multi-copter configuration.

Helicopters use a swashplate to change the pitch of the blades within a rotor revolution. A swashplate includes a rotatable plate bearing with one stationary plate holding a movable plate that rotates parallel to the stationary plate. The movable plate contains linkages to the rotating rotors of the helicopter. The “height” and angle of the plate with respect to the rotational axis are controlled by three or more servo motors. By changing the pitch of the plates, the pitch change is mechanically translated into time varying pitch of the individual rotor blades.

Swashplates are ubiquitous in variable pitch helicopters. However, a swashplate can only produce a sinusoidal variation of the blade pitch during one revolution. There are three variables that the swashplate can adjust in terms of the blade position that include offset, amplitude and phase. The “offset” determines the degree of collective pitch, since it imparts the same blade pitch to all blades around an entire revolution. The “amplitude” denotes half of the angle difference between maximum and minimum blade pitch within a single revolution, and therefore impacts the magnitude of the thrust vector generated, where a greater amplitude results in a greater lateral thrust vector, and thus the higher the speed at which the helicopter laterally translates. The “phase” denotes the angular position in a rotational cycle where the pitch is maximum and minimum, which impacts the direction of the thrust vector on the vehicle to enable translation.

In some instances, it is only necessary to drive the pitch with a constant offset, where this is the only control available, referred to as collective control. The advantage of collective control on a quadcopter is that it is substantially more maneuverable, since the pitch can be changed much faster than the motor speed.

While swashplates have been widely deployed in commercial transport helicopters, they are not popular for SUAVs, since they cause other problems at reduced vehicle scale. At a reduced scale, the mechanical complexity of swashplates results in disproportional added weight compared to the size of the vehicle, reduced reliability due to a mechanical system that involves multiple servo motors, linkages and ball joints, and require significant increases in the vertical form factor or “z-height” profile of the vehicle.

There have been attempts to build a swashplateless helicopter that is capable of collective and cyclic pitch. In one instance, actuators were directly coupled to the blade. In another attempt, trailing edge flaps were configured on the rotor blades to control lift instead of changing the pitch. The disadvantages of these actuator mechanisms are that they require a slip ring to send power and control to the actuators, in addition to doing relatively little to overcome the inherent disadvantages of the mechanical complexity at small scales as described above for traditional swashplate mechanisms.

In another attempt, one group provided a mechanism that uses angled blade hinges combined with motor torque pulses. While this system eliminates some of the drawbacks of swashplates for SUAVs, it is only capable of cyclic pitch. Additionally, the motor torque pulses inherently lack control of cyclic pitch, where the cyclic pitch of this system is based on “open loop” actuation of motor torque, in addition to aero-elasticity of the system, where the friction in the bearings and the stiffness of the hinges could change with operational use.

The form factor of SUAV's in both multi-rotor drones and helicopters using swashplates suffer from other disadvantages at a system level. Specifically, the exposed rotating blades of the rotors rotating at relatively high rotational velocity pose a danger to humans and assets when deployed in commercial environments, especially when they are flying at relatively low altitudes in the presence of people.

What is needed is a quiet, efficient and safe drone having a single large diameter rotor that is capable of collective and cyclic pitch, without the complexities and disadvantages of a swashplate mechanism.

### SUMMARY OF THE INVENTION

To address the needs in the art, a vehicle is provided that includes at least one control motor having a drive motor including a stationary portion and a rotatable portion, where the drive motor rotatable portion is coupled to a rotor shaft, and the drive motor is configured to rotate the rotor shaft, where the rotor shaft is coupled to a rotor blade by a variable pitch rotor blade holder connected to the rotor shaft and connected to the rotor blade, and at least one pitch motor that includes a stationary portion and a rotatable portion, where the stationary portion of the pitch motor is a stator, where the pitch motor rotatable portion is driven by the stator and rotates about an axis coaxial with the rotor shaft, where the rotatable portion includes a pitch control linkage, where the pitch motor rotatable portion is coupled to the variable pitch rotor blade holder through the pitch control linkage, where the pitch motor rotatable portion, the pitch control linkage, the variable pitch rotor blade holder, and the rotor blade are configured to rotate at the same nominal rotational rate as the rotor shaft, where a pitch angle of the variable pitch rotor blade is adjusted according to changes in an angular position of the pitch motor rotatable portion relative to a reference frame of the rotor blade in a rotating state (which is a reference frame that is attached to, and rotates with, the rotor blades), where the change in angular position is according to a control signal to the stator of the pitch motor.

In one aspect of the invention, the at least one pitch motor stationary portion is electromagnetically coupled to the pitch motor rotatable portion, where the pitch motor rotatable portion is controlled by signals from an electrical circuit that is stationary in the vehicle reference frame, which is a reference frame that is attached to the frame of the vehicle and to which the stationary portion of the drive motor is mounted.

According to another aspect of the invention, the at least one pitch motor is independently connected through each the pitch control linkage to a single rotor blade.

In a further aspect of the invention, the at least one pitch motor is independently connected through each pitch control linkage to a plurality of rotor blades. In one aspect, the vehicle further includes a second plurality of rotor blades that are coaxially aligned with the plurality of rotor blades and are driven in an opposite angular direction of the rotor. In one aspect, the second rotor blade is driven by a second drive motor, where the second drive motor includes a second control motor, an electrical motor or a mechanical motor. In another aspect, the drive motor, the pitch motor, and the second drive motor can include a brushed DC motor, a brushless DC (BLDC) motor, a magnetic brake, a combustion engine, a gas motor, an axial flux motor, a voice coil actuator, or a hybrid motor including groups of magnets electromagnetically coupled to current carrying coils, where the current carrying coils or the magnets are configured to move semi-independently. In a further aspect, the pitch motor of the control motor moves the variable pitch blade holder according to an output command of a transmitted control signal, where a pitch motor of the second control motor controls a variable pitch blade holder of the second control motor according to the output command of the transmitted control signal. In yet another aspect each pitch motor is disposed to independently and dynamically adjust the pitch angle of each variable pitch blade holder at a frequency that is higher, the same, or lower than a frequency of a rotational rate of the rotor. The current embodiment further includes a noise abatement housing fixedly connected to the stationary portion of the drive motor, where the noise abatement housing is disposed to surround the rotor and the second rotor, where the inner surface of the noise abatement housing includes a noise abatement structure, where an outer surface of the noise abatement housing includes an impact compliant material.

In one aspect, the invention further includes a plurality of the control motors arranged in a pattern.

According to one aspect of the invention, the drive motor and the pitch motor share a stator.

In another aspect of the invention, control signals are routed through wires that are stationary in the vehicle reference frame.

In yet another aspect of the invention, the drive motor and the pitch motor can include a brushed DC motor, a brushless DC (BLDC) motor, a magnetic brake, a combustion engine, a gas motor, an axial flux motor, a voice coil actuator, or a hybrid motor having groups of magnets electromagnetically coupled to current carrying coils, where the current carrying coils or the magnets are configured to move semi-independently.

In one aspect of the invention, the pitch motor moves the variable pitch blade holder according to an output command of a transmitted control signal.

In another aspect of the invention, the pitch control linkage includes a pair of opposing gears, where a first gear is connected to the variable pitch blade holder and an opposing second gear is connected to the pitch motor rotatable portion. In one aspect, each gear is a bevel gear.

In a further aspect of the invention, each pitch motor is disposed to independently and dynamically adjust the pitch angle of each variable pitch blade holder at a frequency that is higher, the same, or lower than a frequency of a rotational rate of the rotor.

According to another aspect, the invention further includes a noise abatement housing fixedly connected to the stationary portion of the drive motor, where the noise abatement housing is disposed to surround the rotor blade, where the inner surface of the noise abatement housing includes a noise abatement structure, where an outer surface of the noise abatement housing includes an impact compliant material. In one aspect, the noise abatement housing includes carbon fiber sheets with a structural foam or a honeycomb layer disposed therebetween. In another aspect, the housing includes spectra or aramid fibers.

In one embodiment, a control motor is provided that includes a drive motor having a stationary portion and a rotatable portion, where the drive motor rotatable portion is coupled to a rotatable shaft, where the drive motor is configured to rotate the rotatable shaft, where the rotatable shaft is coupled to a rotor element by a variable pitch rotor element holder connected to the rotatable shaft and connected to the rotor element, and at least one pitch motor having a stationary portion and a rotatable portion, where the stationary portion of the pitch motor is a stator, where the pitch motor rotatable portion includes a pitch control linkage, where the pitch motor rotatable portion is connected to the rotor element through the pitch control linkage, where the pitch motor rotatable portion is coupled to the variable pitch rotor element through the pitch control linkage, wherein the pitch motor rotatable portion, the pitch control linkage and the variable pitch rotor element are configured to rotate at the same nominal rotational rate as the rotor shaft, there a pitch angle of the rotor element is adjusted according to changes in an angular position of the pitch motor rotatable portion relative to a reference frame of the rotor element in a rotating state, where the change in angular position is according to a control signal to the stator of the pitch motor.

In another embodiment, the invention includes a rotor blade pitch control mechanism having a plurality of rotor blades configured to rotate around a common axis, at least one pitch motor that includes a rotatable portion and a non-rotating portion, where the non-rotating portion of the pitch motor is a stator, where the rotatable portion rotates coaxially with the rotor blades, where the rotor blades are driven around the common axis by at least one other drive source than the pitch motor, a control system configured to control the non-rotating portion of the pitch motor, and a linkage between the rotatable portion of the pitch motor and at least one of the rotor blades, where the control system changes a pitch angle of at least one linked rotor blade according to changes in an angular position of the pitch motor rotatable portion relative to a reference frame of the at least one linked rotor blade in a rotating state, where the change in angular position is according to a control signal to a stator of the pitch motor.

### BRIEF DESCRIPTION OF THE DRAWINGS

FIGS. 1A-1B show a cutaway view and an isometric view, respectively, of a control motor according to one embodiment of the current invention.

FIGS. 2A-2B show the general principle of operation of the pitch control motor changing the pitch angle of a rotor blade, according to the current invention.

FIG. 2C shows the pitch motor moves the variable pitch blade holder according to an output command of a transmitted control signal that is received by a controller/receiver, according to the current invention.

FIG. 3 shows a compound motor mechanism, according to one embodiment of the current invention.

FIGS. 4A-4D shows some exemplary embodiments of the coax, counter-rotating motor configuration, according to the current invention.

FIGS. 5A-5C show various embodiments of the current invention.

### DETAILED DESCRIPTION

The current invention is directed to a swashplateless helicopter that can be used for Small Unmanned Aerial Vehicles (SUAVs), which results in reduced noise and improved efficiency. According to the current invention, collective and cyclic pitch is provided with a closed loop feedback, which allows dynamic control of the pitch of the rotor blades at any given instant in the rotation of the rotor blade about a rotor shaft axis. The swashplateless mechanism provides heightened reliability over conventional swashplate-based vehicles, and enables effective collective and cyclic pitch that was previously unattainable. The invention enables cyclic pitch that may be non-sinusoidal in nature, as well as independent pitch control of each rotor blade to further reduce resulting noise.

The invention includes an electromechanical system mounted at the hub or about the central axis of the rotor system. In one embodiment, a main drive motor supplies power to spin the rotor blades. Rotor blade pitch angle adjustment is established by electrically controlled elements mounted on a stationary platform and coupled electromagnetically to other non-stationary elements that are mechanically linked to the rotor blades. The electromagnetically and mechanically coupled elements can actuate the rotor blades to enable an arbitrarily defined and temporally variable blade pitch angle during rotation of the rotor blades. The advantage of this mechanism is that the electrical connections or wires for the electromagnetic actuator are stationary, and therefore do not require a slip ring, which avoids the problem of supplying power to a rotating element.

Throughout this disclosure, a rotor comprises a rotor shaft, and rotor blades, where the rotor can include a single rotor blade, an opposing pair of rotor blades, or a plurality of rotor blades. In one example, the current invention provides an improved rotorcraft having two sets of rotor blades stacked along a common axis to form a “coaxial counter-rotating rotorcraft”. A system to control the pitch of the individual rotor blades independent of each other is described herein, in addition to a specially designed “duct” to surround the rotors of the rotorcraft to enhance the efficiency and absorb the sound from the motors and the rotors to reduce the noise from the vehicle. The resulting vehicle displays enhanced efficiency, reduced noise and improved safety when compared with traditional multi-rotor drones.

In one embodiment, the electrically controlled elements are the stators of two separate BrushLess Direct Current (BLDC) motors. The “rotor” elements of these motors are electromagnetically coupled to the stators, and can rotate in response to electrical currents passed through the stator tooth windings.

In another embodiment, a single motor stator arranged about the vehicle rotor hub is electromagnetically coupled to three independent and isolated motor rotors that are arranged adjacent to each other around the circumference of the stator. One motor rotor segment is used to drive the main vehicle rotor, while the other motor rotor segments are each mechanically coupled to the individual blades of the vehicle rotor through gears or other mechanical linkages. It is understood that the motor, shaft, vehicle, and linkage sizes are not indicative of scale and individual mechanical components may be differently sized depending on the vehicle design.

In a further embodiment, the electrically controlled elements are concentrically arranged and electrically isolated stators about a central hub axis of the vehicle rotors. One of these stators is electromagnetically coupled to a motor rotor element that drives the main rotor of vehicle, while the other two stators are electromagnetically coupled to two other isolated motor rotors, each of which is in turn mechanically linked to a blade of the vehicle rotor system.

In yet another embodiment, the electrically controlled stationary element is a coil that is placed close to the rotating hub of the vehicle rotor. The coil is electromagnetically coupled to magnets that are mechanically linked to and rotate with the vehicle rotor blades. When current is passed through the coils at the appropriate moment during the rotation of the rotors, the magnets are actuated, and the mechanical linkage that couples them to the blades causes a pitching action of the blades.

In each of the above embodiments, the rotating motion of the main drive motor and the at least one pitch control actuator must be coordinated for this mechanism to operate properly. The blade pitch is changed by changing the instantaneous position of the pitch control mechanism with respect to the torque generating mechanism.

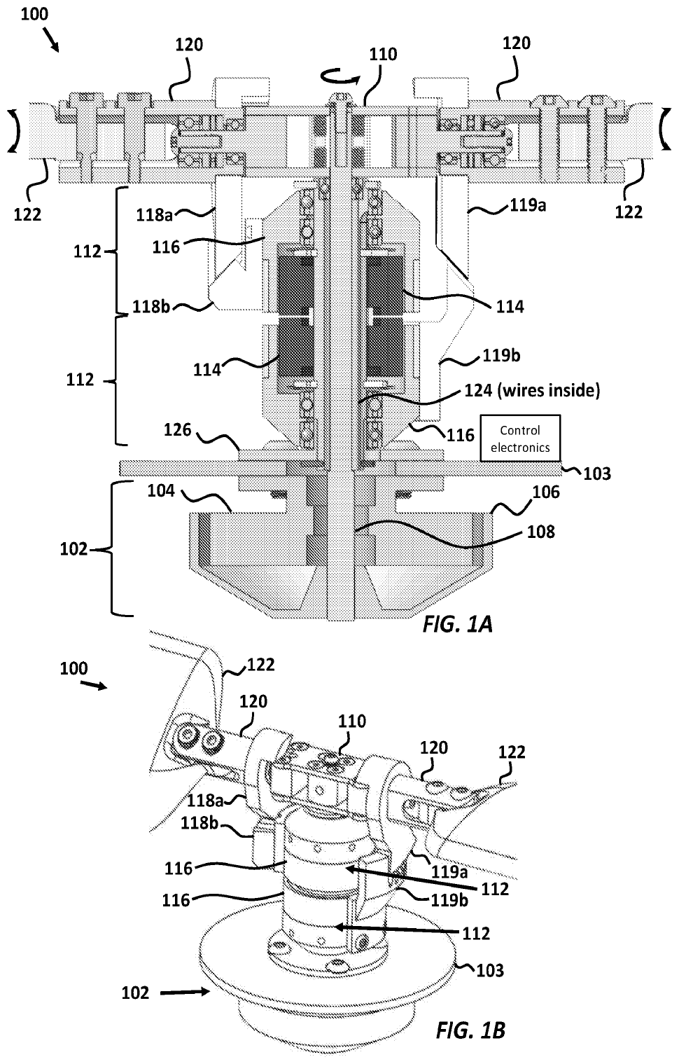

Turning now to the drawings, FIGS. 1A-1B show a cutaway view and an isometric view, respectively, of a control motor 100 according to one embodiment of the current invention, where shown is a drive motor 102 having a stationary portion 104 and a rotatable portion 106, where the drive motor rotatable portion 106 is coupled to a rotor shaft 108, and the drive motor 102 rotates the rotor shaft 108, where the rotor shaft 108 is coupled to a rotor head 110. Further shown are two pitch motors 112, along the rotor shaft 108, having a stationary portion 114 with respect to the rotor shaft 108, and a rotatable portion 116 with respect to the rotor shaft 108, where the stationary portion of the pitch motor 114 can be a stator or connected to a stator. As shown on the left-side of FIG. 1A, the pitch motor stationary portion 114 is located inside the pitch motor rotatable portion 116. Here, each pitch motor rotatable portion 116 includes a pitch control linkage 118b/119b where the pitch motor rotatable portion 116 is connected to the variable pitch blade holder 120 through the pitch control linkages 118a/118b and 119a/119b, having the blade holder linkage 118a/119a and motor linkage 118b/119b. As shown, the pitch motor rotatable portion 116 is coupled to the variable pitch rotor blade holder 120 through the pitch control linkage 118a/118b and 119a/119b, where the pitch motor rotatable portion 116, the pitch control linkage 118a/118b and 119a/119b, the variable pitch rotor blade holder 120, and the rotor blade 122 are configured to rotate at the same nominal rotational rate as the rotor shaft 108, where a pitch angle of the variable pitch rotor blade 122 is adjusted according to changes in an angular position of the pitch motor rotatable portion 116 relative to a reference frame of the rotor blade in a rotating state, where the change in angular position is according to a control signal to the stationary portion 114 of the pitch motor 112.

Variable pitch blade holders 120 are connected to the blade holder linkage 118a/119a, where a pitch angle of the variable pitch blade holder 120 holding a rotor blade 122 is capable of being adjusted by the pitch motor 112 through the use of control signals, where a circuit board having control electronics is disposed on a stationary portion of the vehicle systems, such as the mount plate 103, or a vehicle frame mounted to such mount plate. The pitch motors 112 are independently connected through each pitch control linkage 118b/119b and 118a/119a to a blade holder 120.

One key aspect of the current invention is that the pitch motor stationary portion, which could be the stator of a traditional motor, is controlled with signals without the use of a slip ring, where the pitch motor stationary portion 114 is electromagnetically coupled to the pitch motor rotatable portion 116, which could be the rotor of a traditional motor, such as a basic electric motor or a mechanical motor. The wires for the two pitch motors 112 are routed through a slot that runs up the side of the hollow stationary shaft 124. Since the inner portion of the pitch control motors 112 do not rotate with respect to the main vehicle structure, the wires can remain stationary. The wires are connected to control electronics on the vehicle frame or the mount plate 103, and these electronics allow signals to control the rotational speeds and positions of the pitch control motors 112 and thus the pitch angles of the rotor blades 122.

In this example the pitch control motors 112 are both Brushless DC (BLDC) motors. The torque to rotate the rotor blades 122 through the rotor shaft 108 is provided by the drive motor 102, and in the embodiment shown in FIG. 1A, this is a standard outrunner BLDC motor. There are radial and thrust bearings inside the motor to constrain the shaft to purely rotational motion.

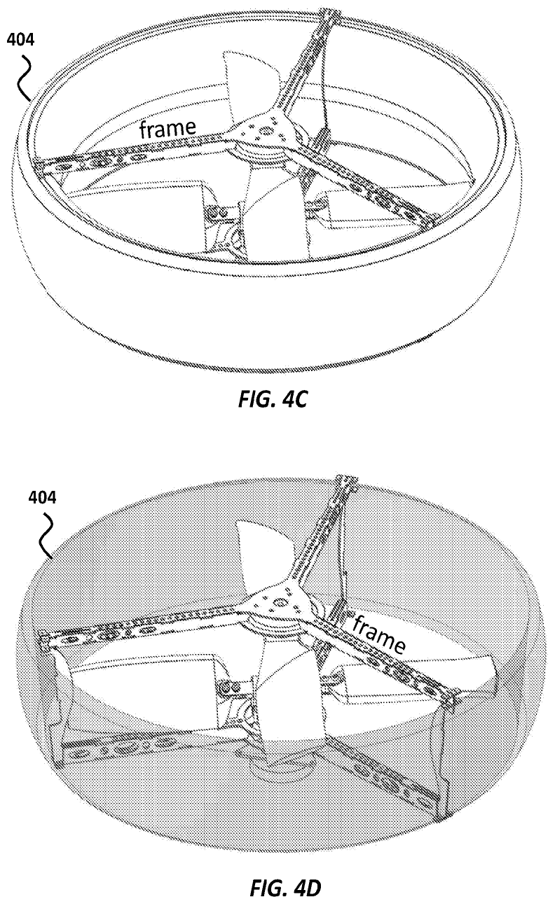

As shown in FIG. 1A, mounted to the stationary part of the drive motor 102 or to the vehicle mount plate 103 is a hollow support shaft 124 for the pitch control motors 112. The stationary part of the drive motor 102 is also mounted to the vehicle, drone, or helicopter frame (see FIGS. 4A-4B). It is understood that the drive source can include motors such as electro-magnetic or combustion engines, as well as mechanical, aerodynamic and fluid dynamic sources. The stators of the two pitch control motors 112 rigidly are attached to the hollow support shaft 124, but their pitch motor rotatable portions 116 are free to rotate independently of each other, and with respect to the drive motor 102. In operation, the pitch motor rotatable portions 116 on the two pitch motors 112 will generally rotate at the same speed. If the rotation rate of one of the pitch control motors 112 changes by a small amount for a short period of time, that will change the phase of that pitch motor 112 with respect to the drive motor 102. This will rotate the bevel gear of the pitch control linkage 118b/119b attached to that pitch motor rotatable portion 116, which in turn will rotate the blade holder 120 through the blade holder link 118a/119a, which could be a bevel gear, and thereby affect the pitch of the rotor blade.

For cyclic pitch, the rotor blade 122 typically experiences a full range of maximum to minimum pitch angles within a single cycle of revolution. To pitch the rotor blade 122 in one direction requires the pitch motor 112 to accelerate to a faster speed than the drive motor 102. That requires energy from the battery. However, after 180 degrees of rotor blade rotation, the pitch of the blade is positioned in the opposite direction, which requires the pitch control motor 112 to decelerate to a slower speed than the drive motor 102. If regenerative braking is used to decelerate the motor, most of the energy that was previously used to change the blade pitch is recovered.

The drive motor 102 can be a brushed DC motor, a brushless DC (BLDC) motor, a magnetic brake, a combustion engine, a gas motor, an axial flux motor, a voice coil actuator, or a hybrid motor having groups of magnets electromagnetically coupled to current carrying coils, where the current carrying coils or the magnets are configured to move semi-independently.

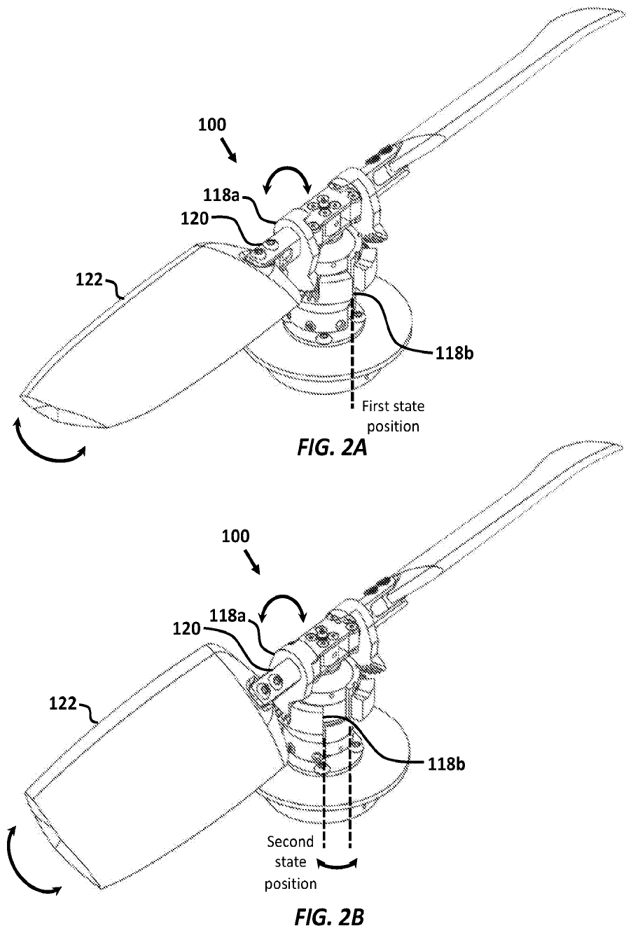

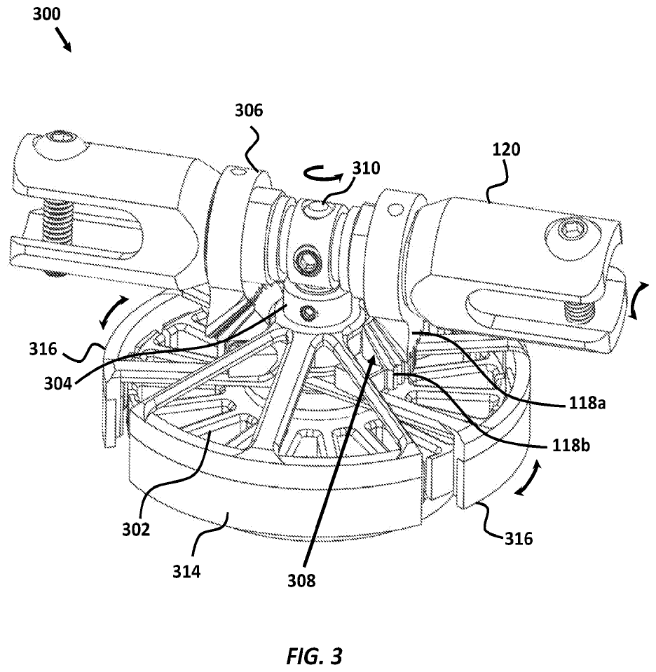

FIGS. 2A-2B show the general principle of operation of the pitch control motor 112 (see FIG. 1A) changing the pitch angle of a rotor blade 122. FIG. 2A-2B show the rotor blade 122 held by the variable pitch blade holder 120, where the variable pitch blade holder 120 is connected to the blade holder link 118a, and the blade holder link 118a is coupled to the pitch control linkage 118b. FIG. 2A shows the rotor blade 122 in a horizontal first state, FIG. 2B shows the rotor blade 122 in an angled second state, where the pitch motor rotatable portion 116 is shown to translate from right to left between FIGS. 2A-2B, respectively, where the pitch control linkage 118b drives the blade holder link 118a to rotate the pitch blade holder 120 and the rotor blade 122.

In a two-bladed rotor, depending on whether collective or cyclic pitch is required, the blades may typically be required to pitch in either the same or opposite directions at any given instant. When they pitch in opposite directions, one pitch motor may be required to accelerate with respect to the drive motor and the other pitch motor may be required to decelerate with respect to the drive motor. If the gear mechanism is designed properly, one blade pitch mechanism requires energy, and the other mechanism releases stored energy. If the gear mechanism requires both pitch control motors to accelerate together, then the battery or a separate capacitor must be used to store the energy during half the rotor rotation.

In one embodiment of the invention, the pitch control motors 112 are BLDC motors. The advantage of this is that the pitch can be adjusted in either direction, depending on whether the actuator phase needs to be positive or negative with respect to the drive motor. The disadvantage is that a complete electronic motor control system is required, and the motor controller must minimize any torque ripple, which would contribute to undesirable blade pitch changes. In one aspect, a Field Oriented Control (FOC) is used for this motor controller to minimize torque ripple. In another aspect of the invention, the drive motor 102 and the pitch motor 112 can include a brushed DC motor, a brushless DC (BLDC) motor, a magnetic brake, a combustion engine, a gas motor, an axial flux motor, a voice coil actuator, or a hybrid motor having groups of magnets electromagnetically coupled to current carrying coils, where the current carrying coils or the magnets are configured to move semi-independently.

The exemplary embodiment of FIGS. 1A-1B shows bevel gears as the linkage 118a/118b disposed to transmit torque from the pitch control motors 112 to the rotor blades 122, however other mechanisms are possible. The bevel gear may be replaced with a spur gear, or a crown gear, or a linkage arm with ball joints from the pitch control motor to the blade.

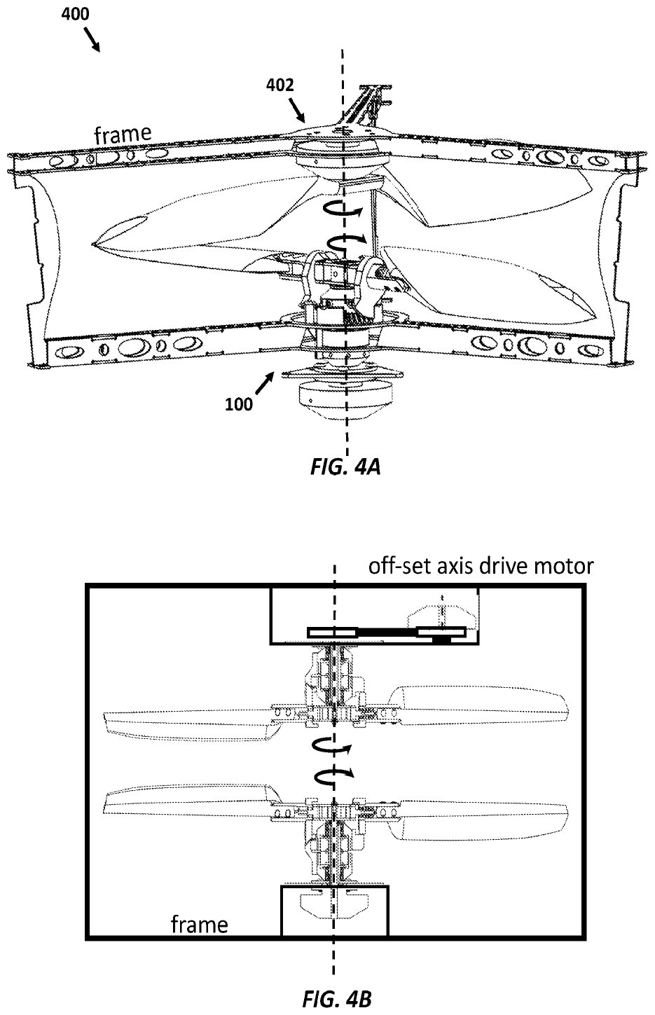

In another embodiment the pitch control motors 112 and the main drive motor 102 may be combined. FIG. 3 shows an example drawing of this embodiment, where the main drive motor and the pitch control motors are replaced with a “compound motor” 300 mechanism. This compound motor mechanism 300 enables spin up of the rotor blades (not shown) attached to the rotor blade holder 120 at the desired rotational rate to generate vehicle lift, but also “pulses” a sub-section of the motor 300 during a cycle, which is translated into pitching of the rotor-blades through the linkage 118a/118b gear mechanism, where a bevel gear is shown here. The embodiment shown in FIG. 3 is essentially the topology of FIG. 1A, but where the drive motor and both pitch motors from FIG. 1A share the same stator 302. The stator 302 comprises several coils (not shown) wound around the stator teeth. Further, in this embodiment, the “rotor” of the motor is the rotatable part of the motor, and is the outer ring that contains the magnets around the periphery. The drive motor rotatable portion 314 as well as the pitch motor rotatable portion 316 make up separate and independent parts of this rotor ring around the common or shared stator 302. A significant difference from a BLDC motor is that in the compound motor 300, the outer rotor ring is not continuous, but split into four segments. Two of these are larger segments and symmetrically positioned around the circumference: the drive rotor portion comprising two elements 314 (only one shown) on either side of the circumference of the rotor that drives the rotor shaft 310, and pitch motor rotatable portions 316 that rotate about the stationary shaft 304 disposed between the two drive rotor portions 314 on either side.

The drive rotor segments are connected to a rotor shaft 310 that runs inside the stationary shaft 304 (which is connected to the stator) but exits out the top of the stationary shaft 304. The two-pitch rotor movable portions 316 are mounted on the outside of the stationary shaft 304 with radial bearings (not shown) such that the pitch motors can rotate about the stationary shaft. Attached to the rotor shaft 310 is a “rotorhead” 306 which extends out orthogonally from the rotor shaft 310. The two rotor blade grips 120 are attached to either end of this rotorhead 306 with bearings, which allows the blade grips 120 to “pitch” about the rotorhead axis. Each blade grip 120 is also connected to one of the pitch rotor movable linkages 118b with a bevel gear 308, such that when the angular position of the pitch motor rotatable portion 116 is changed relative to a reference frame of the rotor blade in a rotating state, the blade holders 120 and blades also change pitch.

In operation, the coils 302 are driven such that both the drive rotor rotatable portion 314 and the pitch motor rotatable portion 316 are at the same phase, which allows the rotor blades to spin at the same rotational rate. In this “rotating reference frame” of the rotor blades, if one of the pitch motor movable portions 316 is briefly “accelerated” or “decelerated” with respect to the drive rotor rotating portion 314, it results in a pitching motion of the linked rotor blade through the bevel gears 308.

The drive electronics for this embodiment of the invention are more complicated because every coil 302 in the stator must be driven independently from all the other coils 302. In a normal motor, there are only 3 wires to control 3 phases in the motor, which requires 6 transistors in total (3 half H-bridges). In this embodiment, each coil is effectively an independent motor phase, and an 18-coil stator (as pictured) would require a half H-bridge on each leg of each coil, for a total of 72 transistors.

An advantage of the current embodiment shown in FIG. 3 is, especially in the case of micro-UAVs (or small rotorcraft drones), one can significantly reduce the “z-height” profile as well as the mass of the vehicle because a single motor can serve the function of the main drive motor as well as the mechanical swashplate. Also, in small UAVs, the small linkages in a swashplate mechanism are typically not very reliable, and require frequent replacement. The gear mechanism in this invention is far more reliable. The ability to change the actuation frequency and wave shape of the pitch actuators also allows reduction in noise by spreading the sound across different frequencies.

Turning now to another aspect of the invention, in the event of power failure, it is desirable for the blades to assume a preferred pitch to facilitate autorotation. In the case of the magnetic brake actuator, a spring is already required, and the spring should be mounted so that it drives the blade pitch to an optimum angle for autorotation when the brake is not actuated. In the case that the actuators are motors, then torsion springs between the blade holders and the rotor may be used to keep the blades at that preferred autorotation pitch if the motors are not driven. Alternatively, the gear may be designed so that a hard stop is encountered at minimum pitch, which is close to the optimum for autorotation.

In general, electric motors have stators with iron cores. One effect of an iron core is that there is always hysteresis losses and eddy current losses in the iron core. According to one embodiment, the invention uses a coreless stator to reduce these losses. Coreless motors also are capable of reducing weigh for a given power output.

In a further aspect of the invention, the vehicle includes a second drive motor that is coaxially aligned with the control motor or off-axis from said control motor, where the second drive motor shaft drives a second set of rotor blades (which are coaxially aligned with the first set of rotor blades) in an opposite direction of the control motor shaft to enable control of yaw of the vehicle during flight. Here, the second drive motor includes a second control motor or a single-axis motor. In a further aspect, the second drive motor is a brushed DC motor, a brushless DC (BLDC) motor, a magnetic brake, a combustion engine, a gas motor, an axial flux motor, a voice coil actuator, or a hybrid motor having groups of magnets electromagnetically coupled to current carrying coils, where the current carrying coils or the magnets are configured to move semi-independently. Further, a pitch motor of the second drive motor moves the variable pitch blade holder according to an output command of a transmitted control signal. Here, each pitch motor is disposed to independently and dynamically adjust the pitch angle of each variable pitch rotor blade. In a further aspect, the embodiment further includes a noise abatement housing fixedly connected to the stationary portion of the drive motor, where the noise abatement housing is disposed to surround the blades of the first rotor, and the blades of the second rotor, where the inner surface of the noise abatement housing includes a noise abatement structure, where an outer surface of the noise abatement housing includes an impact compliant material.

Some exemplary embodiments of the coax, counter-rotating motor configuration 400 are shown in FIGS. 4A-4D, where the current embodiments require no swashplate mechanism, no flybar, and no tail rotor. The embodiment shown in FIG. 4A comprises two sets of counter-rotating rotor blades, with a common rotational axis and spaced a short distance apart, and spinning at substantially the same rotational rate but in opposite directions to eliminate any yaw effects. FIG. 4B shows two sets of coaxial counter-rotating rotor blades, with an off-axis drive rotation.

To generate collective or cyclic pitch of the rotors, we use any of the embodiments described in the invention above. This mechanism can be applied to only one of the motors of the coax pair or both motors. In the case where it is applied to only one of the motors, the other motor can be a single electric motor 402 that only provides rotational torque to the second rotor 100, as shown in FIG. 4A.

In one embodiment, the current invention also has a duct 404 (see FIGS. 4C-4D) that surrounds the two rotors to form a cylindrical shape, where it is understood that the duct 404 can be used to surround a single rotor craft. The duct provides multiple advantages, as listed below:
1. The duct improves the efficiency of the drone by reducing the vortices at the tips of the blades, which act to reduce the lift generated at the tips of the blades. It also increases the induced velocity due to the aerodynamic shape of the duct, increasing total thrust at a given RPM.
2. The duct serves to increase safety by preventing direct exposure to the blades from the sides.
3. The duct serves to absorb some of the noise generated by the motors and the blades.

In order to minimize weight, the duct 404 is made of a thin but relatively stiff material, such as two carbon fiber sheets with a lightweight structural foam or honeycomb layer sandwiched between them.

In one embodiment, the duct 404 is connected to the central axis hub, which is on the same axis as both of the sets of rotor blades through a “frame” as shown in FIGS. 4C-4D. The frame comprises multiple elements: a) “struts” above and below the rotors that extend from the central hub to the outer circumference; and b) vertical members that hold the upper and lower rings together. These members can be made of individual elements, or three independent U-shaped members, each connected to the central hub. The thickness of the elements of the frame is minimized in order not to impede the airflow through the rotors and also to minimize the weight of the frame. However, the frame also needs to be designed to be stiff enough to resist excessive bending in any direction, or excessive torsional twist in the circumferential direction. The struts and other elements of the frame are preferably made of a material like carbon fiber, fiberglass or aramid fiber, which have high stiffness to weight ratios, and can be fabricated at reasonable costs.

The region above and below the rotors may be covered with a “net’ (such as a tennis racket like web or other pattern) to prevent humans or objects from directly coming in contact with the blades from the top or bottom direction, which enhances the safety of the drone. Materials for this “net” include spectra or aramid fibers which are light weight, resist abrasion, can handle high tension, and are readily available.

The outside cylindrical periphery of the duct 404 is covered with a soft shell, as shown in FIGS. 4C-4D, which has elastic properties. The shell's elastic properties could be achieved either by building it from a soft and low stiffness material, such as a foam, or by encasing the region between the shell and the duct with air and making the shell out of a soft compliant material. This approach serves to compress the shell upon impact and absorb much of the kinetic energy through compression of the material or the air pocket within the shell. In this manner, if there is a collision between the drone and a human or another object, the drone absorbs much of the energy upon impact. Examples of the material used for the foam to surround the duct include polyurethane, EPP, MiniCell, etc.

Similarly, the region above the struts connecting the central hub to the outer periphery of the frame is also covered with an elastic member to provide “cushioning” during an impact and allow the drone to absorb a part of the energy upon impact. This part can be made out of numerous plastics such as nylon, PET, PP, fiber reinforced plastics, or a combination of such materials.

With these exemplary designs, all the surfaces of the drone are rounded in order to provide a maximum contact area upon impact, which further reduces injury to humans or puncture or lacerations from sharp corners. When sensors and other electronics are mounted to the drone (including cameras, printed circuit boards, batteries, etc.), these are typically positioned between the duct and the shell, with windows or “ports” in the shell for the camera to be exposed to the outside world. This further ensures that the shape of the drone can be maintained to prevent any sharp corners of the camera or other electronics being exposed upon impact.

In a further aspect, the current invention is configured to provide noise mitigation by a combination of “Individual Blade Control (IBC)” and the duct.

Noise on a rotorcraft comes from several sources that include:

1) “Thickness Noise” is noise produced by the blade displacing the air. It propagates in the plane of the rotor.

2) “Loading Noise” is noise produced by the changing pressures on the blade. This noise is primarily directed beneath the rotor.

3) “Blade Vortex Interaction Noise” (BVI) is noise produced by the interaction of the blade and its own or other shed vortices. Blade vortex interaction happens as a result of unsteady airflow creating unsteady surface pressure along a body. In a helicopter, this creates unsteady loading conditions, which cause low frequency vibrations along the blade as well as reflected acoustic radiation. In traditional helicopters this is often a problem when descending as descent can cause the blades to interact more with their downstream airflow, however it can happen in hover or in forward flight. This can often cause significant vibrations in the airframe which can reduce efficiency and reliability as well as cause passenger discomfort and reduce sensor performance. With a coaxial system, this often becomes the dominant effect as the second blade, by definition, must encounter the vorticity of the first blade. BVI can be reduced by increasing the “vertical miss distance” or reducing the angle of attack.

4) “Broadband Noise” is the noise caused by stochastic effects such as turbulence.

Whereas a traditional helicopter can control a sinusoidal blade pitch through amplitude, phase, and offset by using a swashplate, IBC is a method of helicopter control whose goal is to achieve a Higher Harmonic Control (HHC) of the pitch of the blades. IBC is a tool that is well suited to combat BVI.

Turning now to noise mitigation by the current invention, because reducing the angle of attack has a large impact on BVI, controlling the blade pitch individually according to the current invention allows for a reduction of noise with a minimal reduction in lift. This is because the pitch can be reduced for only the period of time that the vortex interaction occurs over. Several studies have shown that IBC can significantly reduce noise produced by BVI, by up to 12 dB in full size helicopters. Additionally, up to a 10% reduction in power required to hover was observed in helicopters utilizing IBC. NASA has shown [i] that independent blade control can reduce noise by as much as 11 dB.

The duct 404 is configured to reduce BVI as well as broadband noise. This is due to the property of ducts to reduce the vorticity at the tip of the blade. This reduces the magnitude of the vortex when it interacts with the second blade as well as reduces the overall turbulence of the system.

Thickness noise is affected by the duct 404 as well. This is due to the reflection of noise off the internal surfaces of the duct. A selection of acoustic liners is provided for this purpose that absorb these reflected sounds.

The current invention allows for the use of an IBC system and a duct to significantly reduce the sound properties of a rotor.

It is evident from the above that the compound motor systems can result in a swashplate replacement system that allow for several advantages, including:
Weight and “z-profile” reduction: For small drones, the “z-profile” and mass can be reduced because a compound motor replaces the main drive motor and swashplate. In contrast to a quadcopter, this enables a two-motor drone—a compound motor and a regular motor for the counter-rotating rotor.
Improved maneuverability and reliability: Quadcopter translation is accomplished by relative speed changes of the motors, which have large inertia. In contrast, translation of the Vimaan drone only requires pulsing the pitch rotor segment, which is faster. Our drone's maneuverability will rival that of RC helicopters (which are extremely agile), but without the reliability issues of swashplate linkages.
Reduced noise profile: This comes from the ability to individually control the blade pitch during a revolution.

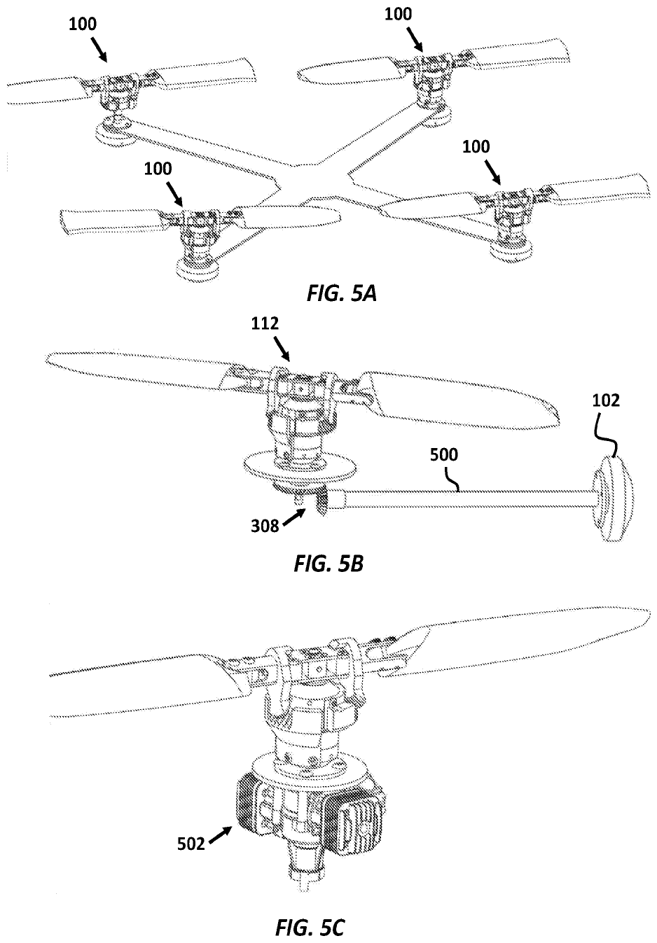

FIGS. 5A-5C show further exemplary embodiments of the invention, where FIG. 5A shows a plurality of the control motors arranged in a pattern. FIG. 5B shows a bevel gear 308 connecting the drive motor 102 to the control motor 112 through an axel 500. FIG. 5C shows a combustion engine 502 operating as a drive motor.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. Some variations include vehicles of different sizes, or vehicles having a gear ratio different from 1:1 could be employed to generate similar results, where the angle change of the pitch motor makes a different angle change in the blade according to the gear ratio. In another variation, the gears could be in the linkages, which could result in different speeds of the various mechanical elements such as pitch motor vs. blade holder.

All such variations are considered to be within the scope and spirit of the present invention as defined by the following claims and their legal equivalents.

What is claimed:

1) A vehicle, comprising at least one control motor, wherein said control motor comprises:
a) a drive motor comprising a stationary portion and a rotatable portion, wherein said drive motor rotatable portion is coupled to a rotor shaft, wherein said drive motor is configured to rotate said rotor shaft, wherein said rotor shaft is coupled to a rotor blade by a variable pitch rotor blade holder connected to said rotor shaft and connected to said rotor blade; and
b) at least one pitch motor comprising a stationary portion and a rotatable portion, wherein said stationary portion of said pitch motor is a stator, wherein said pitch motor rotatable portion is driven by said stator and rotates about an axis coaxial with said rotor shaft, wherein said pitch motor rotatable portion comprises a pitch control linkage, wherein said pitch motor rotatable portion is coupled to said variable pitch rotor blade holder through said pitch control linkage;
wherein said pitch motor rotatable portion, said pitch control linkage, said variable pitch rotor blade holder, and said rotor blade are configured to rotate at the same nominal rotational rate as said rotor shaft, wherein a pitch angle of said rotor blade is adjusted according to changes in an angular position of the said pitch motor rotatable portion relative to a reference frame of said rotor blade in a rotating state, wherein said change in angular position is according to a control signal to said stator of said pitch motor.

2) The vehicle of claim 1, wherein said at least one pitch motor stationary portion is electromagnetically coupled to said pitch motor rotatable portion, wherein said pitch motor rotatable portion is controlled by signals to said pitch motor stationary portion from an electrical circuit that is stationary in the vehicle reference frame.

3) The vehicle of claim 1, wherein said at least one pitch motor is independently connected through each said pitch control linkage to a single said rotor blade.

4) The vehicle of claim 1, wherein said at least one pitch motor is independently connected through each said pitch control linkage to a plurality of said rotor blades.

5) The vehicle of claim 4, wherein said vehicle further comprises a second plurality of said rotor blades that are coaxially aligned with said plurality of rotor blades and are driven in an opposite angular direction of said rotor.

6) The vehicle of claim 5, wherein said second plurality of rotor blades are driven by a second said drive motor, wherein said second drive motor comprises a second said control motor, an electrical motor or a gas motor.

7) The vehicle of claim 6, wherein said drive motor, said pitch motor, and said second drive motor are selected from the group consisting of a brushed DC motor, a brushless DC (BLDC) motor, a magnetic brake, a combustion engine, a gas motor, an axial flux motor, a voice coil actuator, and a hybrid motor comprising groups of magnets electromagnetically coupled to current carrying coils, wherein said current carrying coils or said magnets are configured to move semi-independently.

8) The vehicle of claim 6, wherein said pitch motor of said control motor moves said variable pitch blade holder according to an output command of a transmitted control signal, wherein a pitch motor of said second control motor controls a variable pitch blade holder of said second control motor according to said output command of said transmitted control signal.

9) The vehicle of claim 6, wherein each said pitch motor is disposed to independently and dynamically adjust said pitch angle of each said variable pitch blade holder at a frequency that is higher, the same, or lower than a frequency of a rotational rate of said rotor blade.

10) The vehicle of claim 6 further comprising a noise abatement housing fixedly connected to said stationary portion of said drive motor, wherein said noise abatement housing is disposed to surround said rotor blade and said second rotor blade, wherein said inner surface of said noise abatement housing comprises a noise abatement structure, wherein an outer surface of said noise abatement housing comprises an impact compliant material.

11) The vehicle of claim 1 further comprising a plurality of said control motors arranged in a pattern.

12) The vehicle of claim 1, wherein said drive motor and said pitch motor share said stator.

13) The vehicle of claim 1, wherein control signals are routed through wires that are stationary in said vehicle reference frame.

14) The vehicle of claim 1, wherein said drive motor and said pitch motor are selected from the group consisting of a brushed DC motor, a brushless DC (BLDC) motor, a magnetic brake, a combustion engine, a gas motor, an axial flux motor, a voice coil actuator, and a hybrid motor comprising groups of magnets electromagnetically coupled to current carrying coils, wherein said current carrying coils or said magnets are configured to move semi-independently.

15) The vehicle of claim 1, wherein said pitch motor moves said variable pitch blade holder according to an output command of a transmitted control signal.

16) The vehicle of claim 1, wherein said pitch control linkage comprises a pair of opposing gears, wherein a first said gear is connected to said variable pitch blade holder and an opposing second said gear is connected to said pitch motor rotatable portion.

17) the vehicle of claim 16, wherein each said gear is a bevel gear.

18) The vehicle of claim 1, wherein each said pitch motor is disposed to independently and dynamically adjust said pitch angle of each said variable pitch blade holder at a frequency that is higher, the same, or lower than a frequency of a rotational rate of said rotor.

19) The vehicle of claim 1 further comprising a noise abatement housing fixedly connected to said stationary portion of said drive motor, wherein said noise abatement housing is disposed to surround said rotor blade, wherein said inner surface of said noise abatement housing comprises a noise abatement structure, wherein an outer surface of said noise abatement housing comprises an impact compliant material.

20) The vehicle of claim 19, wherein said noise abatement housing comprises carbon fiber sheets, wherein disposed between said carbon fiber sheets is structural foam or a honeycomb layer.

21) The vehicle of claim 19, wherein said housing comprises spectra or aramid fibers.

22) A control motor comprising:
a) a drive motor comprising a stationary portion and a rotatable portion, wherein said drive motor rotatable portion is coupled to a rotatable shaft, wherein said drive motor is configured to rotate said rotatable shaft, wherein said rotatable shaft is coupled to a rotor element by a variable pitch rotor element holder connected to said rotatable shaft and connected to said rotor element; and
b) at least one pitch motor comprising a stationary portion and a rotatable portion, wherein said stationary portion of said pitch motor is a stator, wherein said pitch motor rotatable portion comprises a pitch control linkage, wherein said pitch motor rotatable portion is connected to said rotor element through said pitch control linkage, wherein said pitch motor rotatable portion is coupled to said variable pitch rotor element through said pitch control linkage;
wherein said pitch motor rotatable portion, said pitch control linkage and said variable pitch rotor element are configured to rotate at the same nominal rotational rate as said rotor shaft, wherein a pitch angle of said rotor element is adjusted according to changes in an angular position of the said pitch motor rotatable portion relative to a reference frame of said rotor element in a rotating state, wherein said change in angular position is according to a control signal to said stator of said pitch motor.

23) A rotor blade pitch control mechanism comprising:
a) a plurality of rotor blades configured to rotate around a common axis;
b) at least one pitch motor comprising a rotatable portion and a non-rotating portion, wherein said non-rotating portion of said pitch motor is a stator, wherein said rotatable portion rotates coaxially with said rotor blades, wherein said rotor blades are driven around said common axis by at least one other drive source than said pitch motor;
c) a control system configured to control said non-rotating portion of said pitch motor; and
d) a linkage between said rotatable portion of said pitch motor and at least one of said rotor blades, wherein said control system changes a pitch angle of at least one said linked rotor blade according to changes in an angular position of said pitch motor rotatable portion relative to a reference frame of said at least one linked rotor blade in a rotating state, wherein said change in angular position is according to a control signal to a stator of said pitch motor.
